(19) United States
(12) Patent Application Publication
(10) Pub. No.: US 2025/0119651 A1
(43) Pub. Date: Apr. 10, 2025

(54) OPTICAL APPARATUS AND IMAGE PICKUP APPARATUS HAVING THE SAME

(71) Applicant: CANON KABUSHIKI KAISHA, Tokyo (JP)

(72) Inventor: TADANORI OKADA, Tochigi (JP)

(21) Appl. No.: 18/901,102

(22) Filed: Sep. 30, 2024

(30) Foreign Application Priority Data
Oct. 6, 2023 (JP) 2023-174175

(51) Int. Cl. H04N 23/695; H04N 23/69

(52) U.S. Cl. CPC H04N 23/695; H04N 23/69

(57) ABSTRACT

The zoom lens includes a zoom operation ring rotatable about an optical axis, a rotary ring rotatable about the optical axis, a linear movement ring movable in an optical axis direction, a spring washer biasing the zoom operation ring and configured to apply a rotational load to the zoom operation ring, and a torque adjustment mechanism configured to adjust the rotational load. The zoom operation ring is rotatable manually or by a drive unit detachable from the zoom lens, the zoom lens includes a rotary member that is operated in conjunction with attachment of the drive unit to the zoom lens, and the torque adjustment mechanism rotates the rotary ring about the optical axis by operating the rotary member, moves the linear movement ring in the optical axis direction by rotating, and changes the rotational load.

### BACKGROUND

### Technical Field

The present disclosure relates to an optical apparatus and an image pickup apparatus having the same.

### Description of the Related Art

In a lens barrel attached on a broadcast camera or a camera dedicated to moving image capturing, a drive unit for electrically driving operation rings such as a zoom ring, a focus ring, and a diaphragm ring is detachably attached. In such a lens barrel to which the drive unit can be attached and detached, when the drive unit is not attached, the operation ring is manually rotated. Therefore, the rotational torque of the operation ring is set to be relatively large so that the operation ring is not inadvertently rotated. On the other hand, in order to suppress power consumption when the drive unit is attached, it is preferable that the rotational torque required for rotating the operation ring is small.

In International Publication No. WO2014/034699, since the frictional load is applied to one point of the operation ring from the radial direction, backlash occurs when the operation ring is reversed, and there is a concern that a sense of discomfort may occur during operation. In addition, the backlash causes a deviation between the operation of the operation ring and the movement of the optical system, which may cause a delay in the image with respect to the operation of the operation ring.

### SUMMARY

An object of the present disclosure is to provide an optical apparatus that does not cause a sense of discomfort in operation.

In order to achieve the above-mentioned objects, according to some embodiments, an optical apparatus comprising: a first member rotatable about an optical axis, a second member rotatable about the optical axis, a third member movable in an optical axis direction, a first biasing member biasing the first member and configured to apply a rotational load to the first member, and an adjustment mechanism configured to adjust the rotational load, wherein the first member is rotatable manually or by a drive unit detachable from the optical apparatus, wherein the optical apparatus includes an operation member that is operated in conjunction with attachment of the drive unit to the optical apparatus, and wherein the adjustment mechanism rotates the second member about the optical axis by operating the operation member, moves the third member in the optical axis direction by rotating, and changes the rotational load.

Further features of the present disclosure will become apparent from the following description of exemplary embodiments with reference to the attached drawings.

### BRIEF DESCRIPTION OF THE DRAWINGS

FIG. 1 is a cross-sectional view of a zoom lens (100) according to an embodiment.

FIG. 2 is an enlarged cross-sectional view of members related to the zoom operation ring (21).

FIG. 3 is an exploded perspective view of members related to the zoom operation ring (21).

FIG. 4 is a partial perspective view of the zoom lens (100).

FIG. 5 is an enlarged view of a portion A in FIG. 4.

FIG. 6 is a partial perspective view illustrating the appearance of the zoom lens (100).

FIG. 7A is a perspective view illustrating the torque adjustment mechanism in a state where the drive unit (30) is not attached. FIG. 7B is a perspective view of the torque adjustment mechanism in a state where the drive unit (30) is attached.

FIG. 8 is a cross-sectional view taken along a sectional line VIII-VIII in FIG. 7A.

FIG. 9A is a cross-sectional view taken along sectional line IX (A)-IX (A) in FIG. 6 and illustrating a state in which the drive unit (30) is not attached. FIG. 9B is a cross-sectional view taken along sectional line IX (B)-IX (B) of FIG. 6 and illustrating a state where the drive unit (30) is attached.

FIG. 10A is a view illustrating the torque adjustment mechanism in a state where the drive unit (30) is attached. FIG. 10B is a view illustrating the torque adjustment mechanism in a state where the drive unit (30) is attached.

FIG. 11 is a schematic diagram illustrating a configuration example of an image pickup apparatus.

### DESCRIPTION OF THE EMBODIMENTS

Exemplary embodiments of the present invention will now be described in detail in accordance with the accompanying drawings. The same reference numerals indicate the same or corresponding parts throughout the drawings. Note that, although this embodiment describes an interchangeable lens, which is an example of an optical apparatus, various modifications and variations of this disclosure, such as an integrated lens camera, are possible within the scope of its gist.

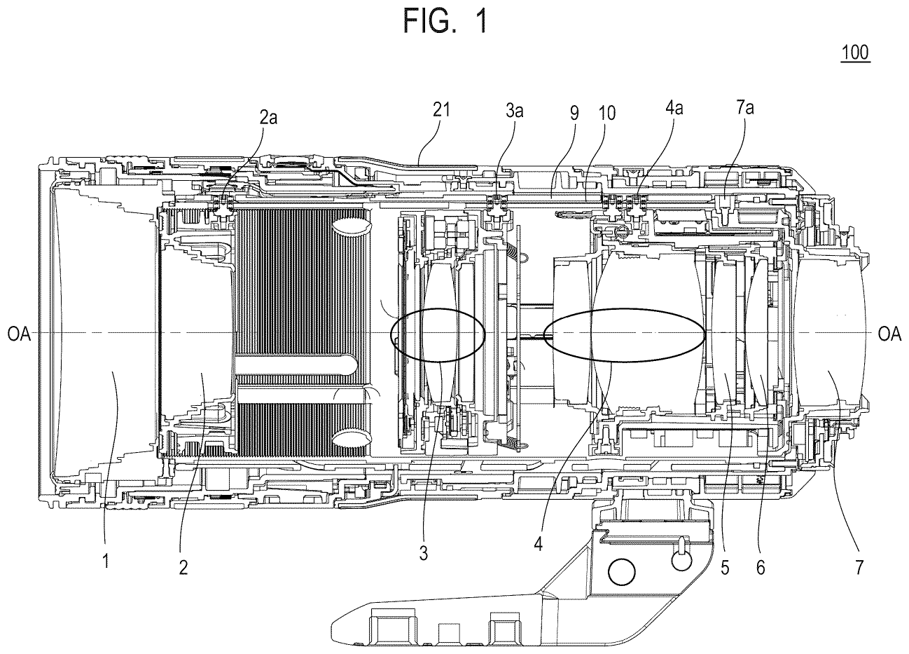

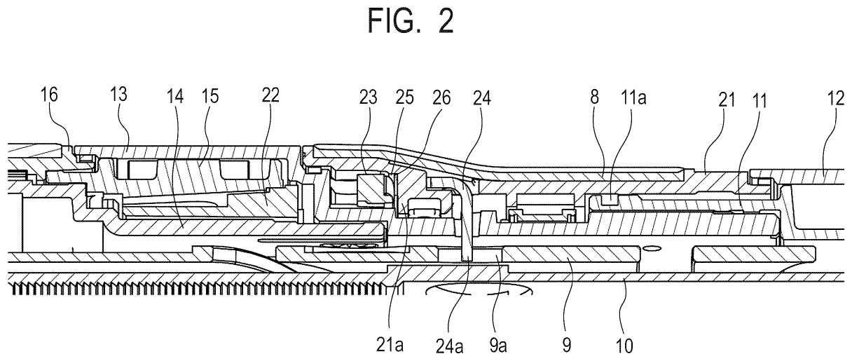

FIG. 1 is a cross-sectional view of a zoom lens 100 (optical apparatus) according to an embodiment of the present disclosure. A first lens unit 1, a second lens unit 2, a third lens unit 3, a fourth lens unit 4, a fifth lens unit 5, a sixth lens unit 6, and a seventh lens unit 7 are lens units constituting an image pickup lens of the zoom lens 100. The zoom lens 100 further includes a zoom operation ring 21 (first member), a rotary ring 22 (second member) illustrated in FIG. 2, a linear movement ring 23 (third member), a torque adjustment mechanism that adjusts a rotational load of the zoom operation ring 21, and the like. The zoom operation ring 21 can be rotated manually or by a drive unit 30 (to be described later) that can be attached to and detached from the zoom lens 100. By rotating the zoom operation ring 21, the lens units other than the first lens unit 1 move along their respective movement trajectories in the optical axis direction, thereby performing zooming. That is, the zoom operation ring 21 can move the optical system in the zoom lens 100 along an optical axis. The first lens unit 1 is a fixed lens unit that does not move for zooming. A direction OA in FIG. 1 is an optical axis direction.

A cam follower 2a, a cam follower 3a, a cam follower 4a, and a cam follower 7a are attached to each of the second lens unit 2, the third lens unit 3, the fourth lens unit 4, and the seventh lens unit 7. They are engaged with a cam groove provided in the cam ring 9 and a rectilinear groove provided in the guide barrel 10 and are moved in the optical axis direction by a known cam mechanism.

FIG. 2 is a partial cross-sectional view of the zoom lens 100 and illustrates members related to the zoom operation ring 21. The zoom operation ring 21 is fitted to an outer diameter portion of the rear metal ring 11 which is fixed, and an inner-diameter projection (not illustrated) of the zoom operation ring 21 is engaged with a circumferential groove 11a provided in the rear metal ring 11, so that the zoom operation ring 21 is rotatably attached about the optical axis in a state where movement in the optical axis direction is restricted. A rear exterior ring 12 is fixed to the image plane side of the rear metal ring 11 with screws (not illustrated). The intermediate exterior ring 13 is fitted to an inner diameter portion of the rear metal ring 11 and is fixed by a screw (not illustrated). A front exterior ring 14 is fixed to an object side of the intermediate exterior ring 13 with a screw (not illustrated). A front metal ring 15 is fixed to the outer diameter side of the front exterior ring 14 by screws (not illustrated). A focus ring 16 rotatably held at a fixed position is attached to the object side of the front metal ring 15.

A zoom key 24 is fixed to the zoom operation ring 21 by a screw (not illustrated), and a tip portion 24a of the zoom key 24 is engaged with a key groove 9a of the cam ring 9, so that the cam ring 9 can be integrally rotated by rotating the zoom operation ring 21. By covering the zoom operation ring 21 with the zoom rubber ring 8, the zoom rubber ring 8 serves as a non-slip member for improving a manual operation feeling and serves to hide the zoom key 24 and the screws.

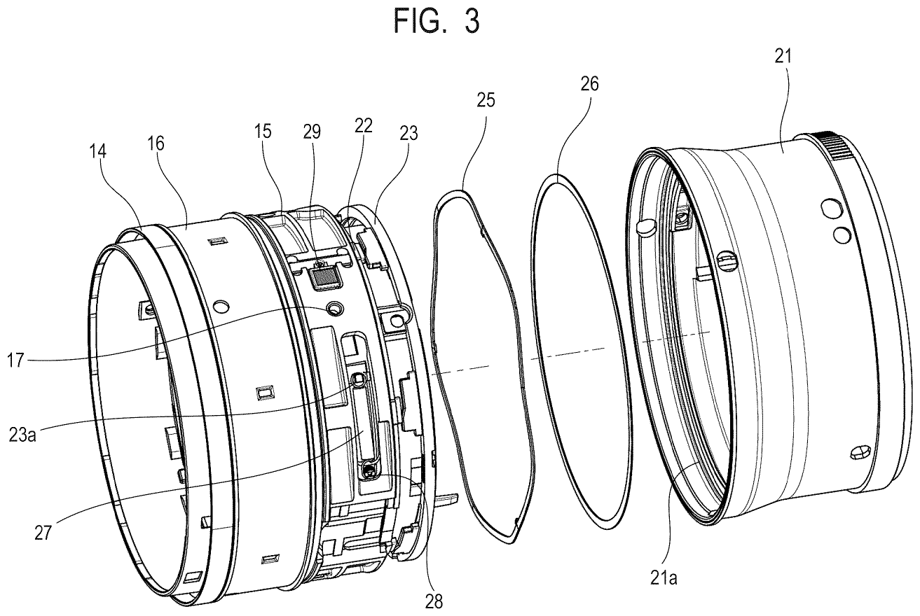

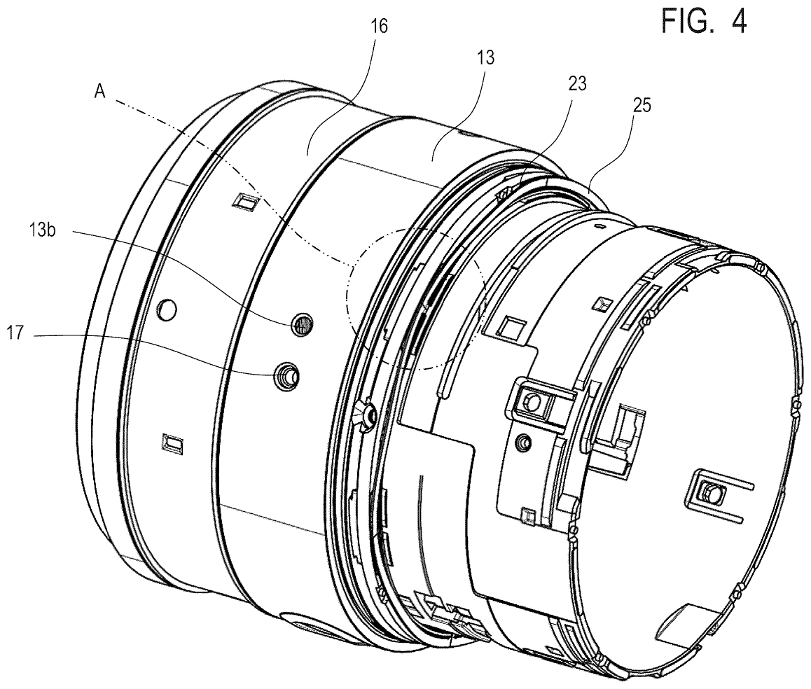

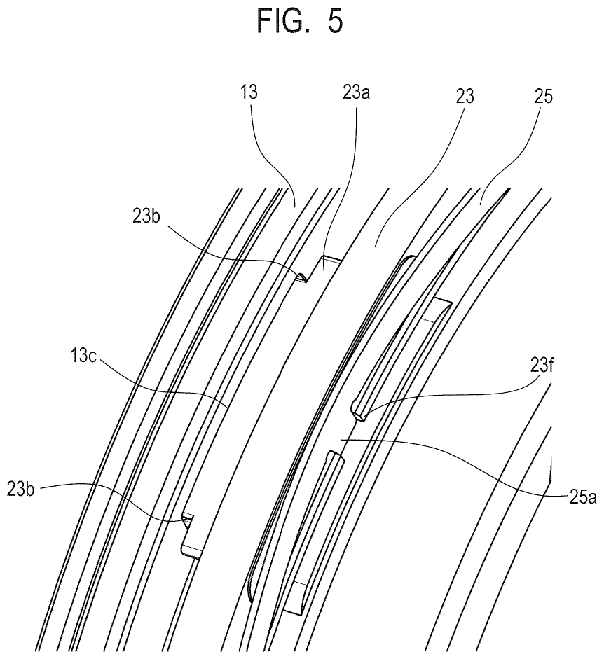

Next, a mechanism for applying a rotational load to the zoom operation ring 21 will be described in detail. FIG. 3 is an exploded perspective view illustrating members around the zoom operation ring 21, FIG. 4 is a perspective view illustrating a state where the members illustrated in FIG. 3 are assembled, and FIG. 5 is an enlarged view of a portion A illustrated in FIG. 4.

A rotary ring 22 is fitted and held on the inner peripheral side of the front metal ring 15 so as to be rotatable about the optical axis. The linear movement ring 23 that moves linearly along the optical axis is disposed on the image plane side of the rotary ring 22, and the linear movement ring 23 is held so as to be movable only in the optical axis direction. A spring washer 25 (first biasing member) is disposed so as to be in contact with an end surface of the linear movement ring 23 and biases a sliding end surface 21a provided on the zoom operation ring 21 toward the image plane side in the optical axis direction via an annular friction member 26 (sliding ring, Lumirror sheet). That is, the spring washer 25 biases the friction member 26 so that the friction member 26 comes into contact with the zoom operation ring 21, and the friction member 26 applies a rotational load to the zoom operation ring 21 by coming into contact with the zoom operation ring 21.

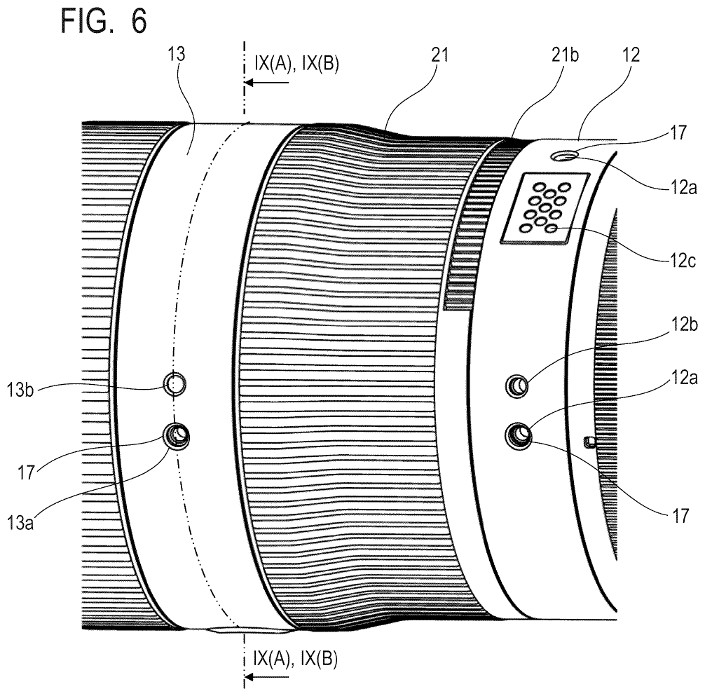

FIG. 6 is a perspective view illustrating the appearance of the zoom lens 100. The zoom lens 100 is detachably provided with a drive unit 30 (not illustrated) for electrically rotating the zoom operation ring 21 from the outside in consideration of moving image photographing. A screw hole portion 17 (attaching portion) for fixing the drive unit 30 is provided in an opening portion 13a provided in the intermediate exterior ring 13. In addition, a screw hole portion 17 for fixing the drive unit 30 is also provided in each of two opening portions 12a provided in the rear exterior ring 12. Three screw hole portions 17 in total are firmly fixed to the front metal ring 15 and the rear metal ring 11 disposed inside the exterior, respectively, thereby ensuring the strength when the drive unit 30 is attached.

A pin (not illustrated) provided on the drive unit 30 is inserted into the positioning hole 12b provided in the rear exterior ring 12, so that the positioning hole 12b serves as a guide at the time of attaching and acts to perform accurate positioning. Contact points 12c perform electrical communication and power supply between the zoom lens 100 and the drive unit 30 when the drive unit 30 is attached. A gear portion 21b provided in the zoom operation ring 21 meshes with an outputting gear (not illustrated) provided in the drive unit 30, and the zoom operation ring 21 is electrically rotated by a rotational force of the outputting gear. The adjustment hole portion 13b (opening portion) provided in the outer peripheral portion of the intermediate exterior ring 13 is a hole for operating a rotary member 29 (operation member), which will be described later, disposed inside the zoom lens 100.

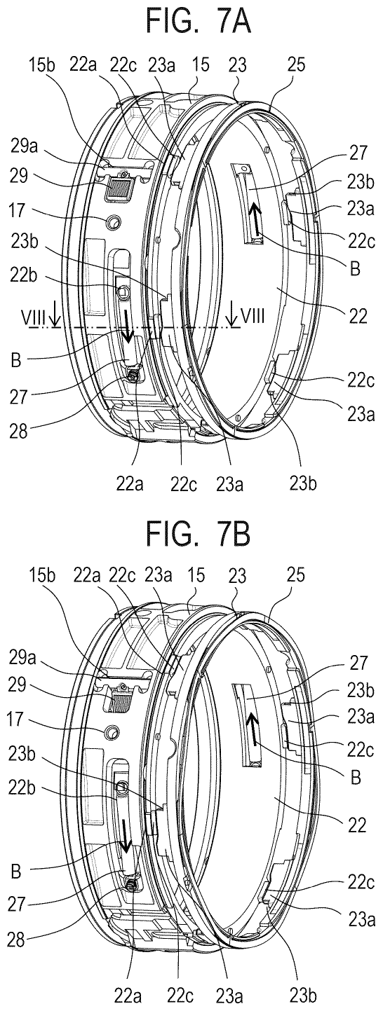

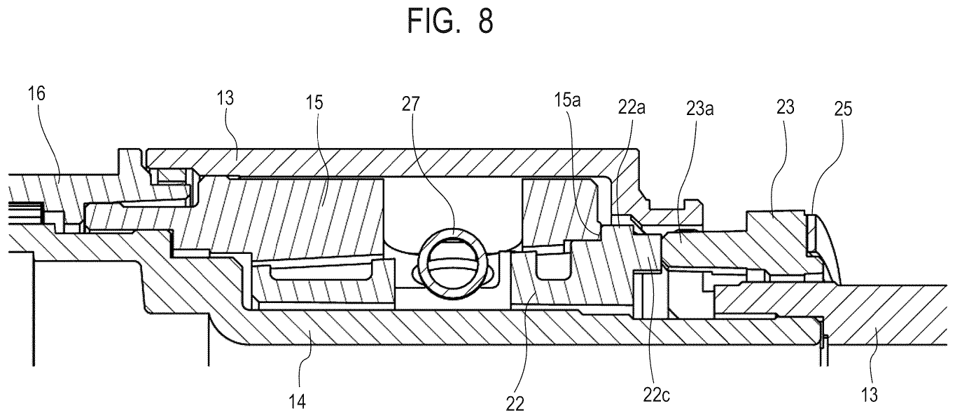

Next, the operation of the torque adjustment mechanism will be described in detail. FIG. 7A is an assembly perspective view of main members constituting the torque adjustment mechanism, illustrating a state where the drive unit 30 is not attached, and FIG. 7B illustrates a state where the drive unit 30 is attached. FIG. 8 is a cross-sectional view taken along a sectional line VIII-VIII in FIG. 7A.

In FIG. 7A and FIG. 7B the rotary ring 22 is fitted to and held by the inner diameter portion of the front metal ring 15. As illustrated in FIG. 8, a sliding projection 22a projecting from an end surface of the rotary ring 22 toward the outer diameter slides on an end surface 15a of the front metal ring 15, whereby the rotary ring 22 is held at a predetermined position so as to be rotatable about the optical axis. One end of a coil spring 27 (second biasing member), which is a tension spring, is attached to a hook portion 22b (see FIG. 7A) of the rotary ring 22, and the other end of the coil spring 27 is fixed to a spring hanging screw 28 provided on the front metal ring 15. Coil springs 27 are also disposed at opposing positions across the optical axis and apply a biasing force to the rotary ring 22 so as to rotate in a direction B illustrated in FIG. 7A and rotate the rotary ring 22 in the direction in which the spring washer 25 is biased.

On the end surface of the rotary ring 22, six pressure contact projections 22c (projections) each having a plane portion on the image plane side and protruding in the optical axis direction are provided at equal intervals in the circumferential direction. Each of the pressure contact projections 22c is arranged so that an end surface cam portion 23a provided on the linear movement ring 23 abuts thereon. Linear guide sliding portions 23b are provided on both sides of the end surface cam portion 23a in the circumferential direction and are engaged with linear guide hole 13c (see FIG. 5) provided in the intermediate exterior ring 13, so that the rotary ring 22 is held so as to be movable only in the optical axis direction. The end surface cam portion 23a and the linear guide hole 13c are provided at six positions, but if they are fitted at all the positions, there is a possibility that the movement is deteriorated due to manufacturing errors, the end surface cam portion 23a and the linear guide hole 13c are fitted and slid at only three positions of the six positions.

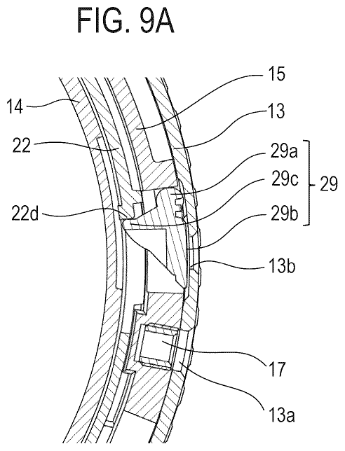

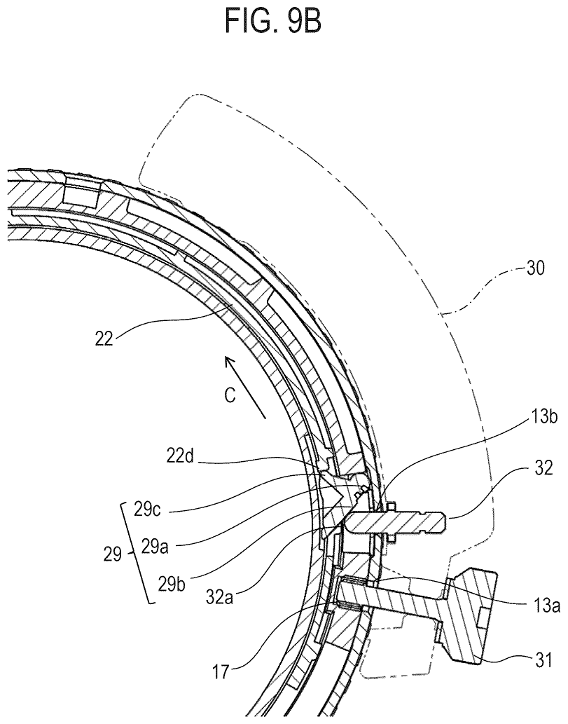

The rotary member 29 is provided on the outer diameter side of the front metal ring 15, and a rotary shaft portion 29a (swing shaft portion) of the rotary member 29 is fitted into a groove portion 15b provided in the front metal ring 15, whereby the rotary member 29 is held rotatably about the rotary shaft portion 29a. The rotary member 29 has a plane portion 29b (first contact portion) extending from the rotary shaft portion 29a and a cylindrical projection 29c (second contact portion) which is positioned in a direction perpendicular to the plane portion 29b and contacts the rotary ring 22. (See FIG. 9A and FIG. 9B)

Next, the operation of the torque adjustment mechanism when the drive unit 30 is attached will be described. FIG. 9A and FIG. 9B are cross-sectional views taken along sectional lines IX(A)-IX(A) and IX(B)-IX(B) of FIG. 6, and FIG. 9A illustrates a state where the drive unit 30 is not attached, and FIG. 9B illustrates a state where the drive unit 30 is attached. As illustrated in FIG. 9B, the drive unit 30 is fixed by tightening three fixing screws 31 provided in the drive unit 30 into screw holes 17 provided in the zoom lens 100. At that time, a distal end portion 32a of the operation pin 32 (acting portion) provided in the drive unit 30 passes through the adjustment hole portion 13b and presses the plane portion 29b of the rotary member 29. The rotary member 29 is operated in conjunction with the attachment of the drive unit 30 to the zoom lens 100. And the rotary member 29 rotates about the rotary shaft portion 29a, and the cylindrical projection 29c presses a circumferential end surface 22d of the rotary ring 22. The rotary ring 22 is rotated about the optical axis by the operation of the rotary member 29, and the rotational force of the rotary ring 22 is converted into a driving force in the optical axis direction. The rotation of the rotary ring 22 moves the linear movement ring 23 in the optical axis direction, changing the positions of the spring washer 25 and the friction member 26 in the optical axis direction, and the rotational load caused by the friction member 26 can be changed.

The rotary ring 22 is urged by two coil springs 27 so that the cylindrical projection 29c and the circumferential end surface 22d are always in contact with each other. Therefore, in conjunction with the attaching of the drive unit 30, the rotary ring 22 is rotated in a direction C illustrated in FIG. 9B against the biasing force of the coil spring 27.

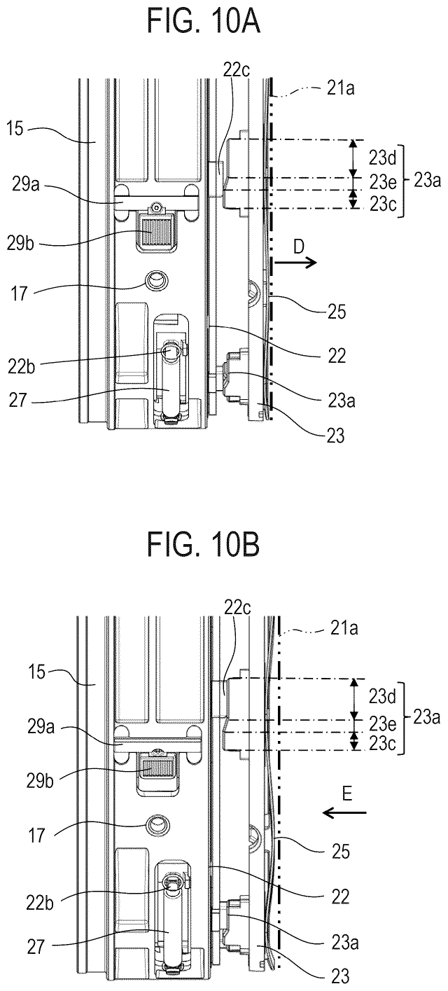

FIG. 10A and FIG. 10B are views for explaining an operation state of the linear movement ring 23 and the spring washer 25 constituting the torque adjustment mechanism, FIG. 10A illustrates a state where the drive unit 30 is not attached, and FIG. 10B illustrates a state where the drive unit 30 is attached. As illustrated in FIG. 10A, in a state where the drive unit 30 is not attached, the pressure contact projection 22c provided on the rotary ring 22 is in contact with a high plane portion 23c of the end surface cam portion 23a. In this state, the spring washer 25 is deformed to predetermined thicknesses and bias the zoom operation ring 21 toward the image plane side with an appropriate load with the friction member 26 interposed therebetween. The line in the drawing indicates the position of the sliding end surface 21a of the zoom operation ring 21.

From this state, when the drive unit 30 is attached as illustrated in FIG. 10B, the contact position of the pressure contact projection 22c moves to a bottom plane portion 23d by the rotation of the rotary ring 22. At this time, the linear movement ring 23 is constantly pressed against the rotary ring 22 by a biasing force of the spring washer 25. Therefore, the pressure contact projection 22c is always in contact with the bottom plane portion 23d from the high plane portion 23c through a connecting slope portion 23e (slope portion) inclined with respect to the optical axis direction. That is, the rotary ring 22 is rotated, and the linear movement ring 23 is moved in the optical axis direction by the connecting slope portion 23e with which the pressure contact projection 22c is brought into contact, thereby changing the biasing force of the spring washer 25. Further, even when the drive unit 30 is attached to the zoom lens 100, the biasing force of the spring washer 25 acts on the zoom operation ring 21.

In this state, since the linear movement ring 23 moves in a direction E illustrated in FIG. 10B, the biasing force of the spring washer 25 decreases, the friction force generated between the spring washer 25 and the friction member 26 decreases, and as a result, the rotational load (rotational torque) of the zoom operation ring 21 decreases. That is, the linear movement ring 23 moves so as to change the biasing force of the zoom operation ring 21.

On the other hand, when the drive unit 30 is removed, the state returns to the state illustrated in FIG. 10A. At this time, the rotary ring 22 is rotated by the biasing force of the coil spring 27, and the pressure contact projection 22c moves from the bottom plane portion 23d to the high plane portion 23c via the connecting slope portion 23e, whereby the linear movement ring 23 moves in a direction D illustrated in FIG. 10A. As a result, the biasing force of the spring washer 25 increases, and the friction force with the friction member 26 increases, whereby the rotational torque of the zoom operation ring 21 increases.

The heights of the high plane portion 23c and the bottom plane portion 23d in the optical axis direction are adjusted together with the biasing force of the spring washer 25 so that the rotational torque of the zoom operation ring 21 is appropriate. That is, when the zoom operation ring 21 is manually operated, the rotation torque of the high plane portion 23c is set such that the zoom operation ring 21 can be easily set to a target zoom position and the zoom operation ring 21 does not inadvertently rotate depending on the posture of the zoom lens 100. Further, the bottom plane portion 23d is set to have a low rotational torque so that the zoom operation ring 21 can be rotated by the driving torque of the drive unit 30 under any environment assumed at the time of photographing. A compression amount of the spring washer 25 is adjusted so that a certain degree of biasing force remains in the zoom operation ring 21 so that the rotary ring 22 and the linear movement ring 23 do not rattle. When the rotary ring 22 is within a predetermined range of a rotation angle, that is, within the range of the rotation angle of the rotary ring 22 in which the pressure contact projection 22c of the rotary ring 22 abuts on the connecting slope portion 23e, the biasing force of the spring washer 25 changes in accordance with the rotation angle. In addition, the biasing force of the spring washer 25 does not change in the rotation angle (outside the predetermined range of the rotation angle) of the rotary ring 22 in which the pressure contact projection 22c comes into contact with the high plane portion 23c or the bottom plane portion 23d.

As illustrated in FIG. 5, the spring washer 25 is provided with three rotation-preventing projections 25a on the inner-diameter side, and the spring washer 25 is prevented from rotating about the optical axis by fitting the rotation-preventing projections 25a into the 23f of the positioning groove provided in the linear movement ring 23. Therefore, the friction force applied to the zoom operation ring 21 acts between the spring washer 25 and the friction member 26 or between the friction member 26 and the sliding end surface 21a provided on the zoom operation ring 21. In the zoom lens 100, the point contact portions between the six ridge portions of the spring washer 25 and the friction member 26 mainly slide, but the friction member 26 and the zoom operation ring 21 may slide.

The reason why the end surface cam portion 23a is constituted by two plane portions and one inclined surface portion is that manufacturing errors of members do not affect the rotational torque of the zoom operation ring 21. The rotation angle of the rotary ring 22 varies depending on the length of the operation pin 32 provided in the drive unit 30, the degree of fastening of the fixing screw 31, and manufacturing errors of other members on the zoom lens 100 side. Even in this case, when the drive unit 30 is not attached, the dimensions are set so that the pressure contact projection 22c is always placed on the plane portion of the high plane portion 23c. Further, when the drive unit 30 is attached, the dimensions are set so that the pressure contact projection 22c comes into contact with a flat surface of the bottom plane portion 23d.

Further, the angle of the inclined surface of the connecting slope portion 23e is set such that the biasing force of the spring washer 25 can be increased to a predetermined value by the biasing force of the coil spring 27 under the condition that there are no defects due to the above-described manufacturing errors. That is, the biasing force of the coil spring 27 for rotating the rotary ring 22 and moving the linear movement ring 23 in the optical axis direction via the connecting slope portion 23e needs to be set to be always stronger than the biasing force of the spring washer 25 for moving the linear movement ring 23. The biasing force applied to the linear movement ring 23 by the coil spring 27 is larger than the biasing force by the spring washer 25.

When the drive unit 30 is removed, the rotary member 29 is rotated by the rotation of the rotary ring 22 due to the action of the coil spring 27, and the plane portion 29b is pressed against the inside diameter surface of the intermediate exterior ring 13 to close the adjustment hole portion 13b. This prevents dust and water droplets from entering from the outside.

As described above, in the zoom lens 100 to which the drive unit 30 capable of electrically driving the zoom operation ring 21 from the outside can be attached the rotational torque of the zoom operation ring 21 can be adjusted by the torque adjustment mechanism in conjunction with the attachment of the drive unit 30. As a result, it is possible to set the torque so that favorable zoom adjustment can be performed by manual operation in a state where the drive unit 30 is not present, and it is possible to reduce the rotational torque of the zoom operation ring 21 and lower the drive torque of the drive unit 30 when the drive unit 30 is attached. As a result, power saving and miniaturization of the drive unit 30 can be realized.

In addition, according to the present disclosure, the movement of the rotary member 29 by the operation pin 32 provided in the drive unit 30 is converted into the rotational movement of the rotary ring 22, so that the movement at one place is changed into the movement of the entire circumference of the ring. As a result, contact is made at a plurality of points in the circumferential direction, and the zoom operation ring 21 can be uniformly urged in the optical axis direction. A certain amount of play (backlash) is required in the portion where the diameter of the zoom operation ring 21 is fitted. In a case where only one portion is biased in a radial direction as in the related art, when the reversing operation is performed, the rotating member idles about the biased portion until the backlash is eliminated and starts to rotate for the first time after the backlash is eliminated. Thus, the operation feeling is deteriorated (inversion backlash is felt).

In addition, when there is inversion backlash, the internal optical system is not moved until the backlash is eliminated. Therefore, it takes time from the start of operation of the operation ring to the start of movement of an image or a video, or the movement of the image is delayed with respect to the operation, which causes a sense of discomfort.

In the present disclosure, by biasing the entire operation ring, the inversion backlash is less likely to occur. Therefore, a smooth manual operation can be realized, and since there is no delay in the movement of the operation ring and the optical system, a shift between the operation and the image is less likely to occur, and the occurrence of a sense of discomfort during the operation can be suppressed. According to the present disclosure, it is possible to provide an optical apparatus that does not cause a sense of discomfort in operation.

Although the zoom operation ring 21 for adjusting the focal length is used as the operation ring in the present embodiment, the same effect can be obtained even when the zoom operation ring 21 is applied to a ring in which a manual operation ring is electrically driven, such as a manual focus ring for focus adjustment or a diaphragm adjustment ring. Although a metal spring washer (wave washer) is used to bias the operation ring, a rubber or sponge-like resin product may be used.

### (Application Example)

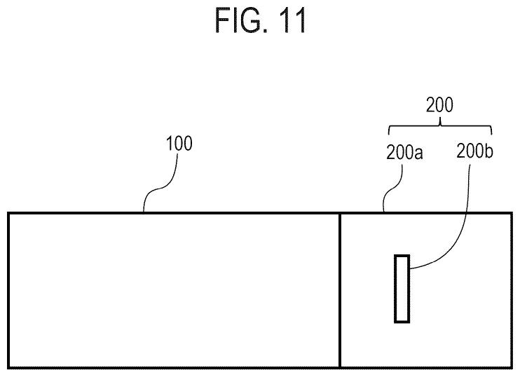

FIG. 11 is a schematic diagram illustrating a configuration example of a camera apparatus 200 (image pickup apparatus) using the zoom lens 100 to which the present disclosure is applied. The image pickup apparatus includes a zoom lens 100 and a camera apparatus 200 including a camera body 200a having an image sensor 200b for capturing an image of an object formed by the zoom lens 100. Further, the image pickup apparatus may have a configuration in which the zoom lens 100 is detachably attached to the camera body 200a of the camera apparatus 200.

While the exemplary embodiments of the present invention have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-174175, filed Oct. 6, 2023, which is hereby incorporated by reference herein in its entirety.

What is claimed is:

1. An optical apparatus comprising:
a first member rotatable about an optical axis,
a second member rotatable about the optical axis,
a third member movable in an optical axis direction,
a first biasing member biasing the first member and configured to apply a rotational load to the first member, and
an adjustment mechanism configured to adjust the rotational load,
wherein the first member is rotatable manually or by a drive unit detachable from the optical apparatus,
wherein the optical apparatus includes an operation member that is operated in conjunction with attachment of the drive unit to the optical apparatus, and
wherein the adjustment mechanism rotates the second member about the optical axis by operating the operation member, moves the third member in the optical axis direction by rotating, and changes the rotational load.

2. The optical apparatus according to claim 1, wherein the second member includes projections that protrude in the optical axis direction and come into contact with the third member, and the third member has a slope portion inclined with respect to the optical axis direction,
wherein the adjustment mechanism changes a biasing force of the first biasing member by rotating the second member by operating the operation member and moving the third member in the optical axis direction by the slope portion with which the projections come into contact.

3. The optical apparatus according to claim 1, wherein the operation member includes a swing shaft portion, a first contact portion extending from the swing shaft portion, and a second contact portion positioned in a direction perpendicular to the first contact portion and abutting on the second member,
wherein when the drive unit is attached on the optical apparatus, the first contact portion is pressed, the operation member rotates about the swing shaft portion, and the second contact portion rotates the second member.

4. The optical apparatus according to claim 1, wherein a second biasing member is attached to the second member, and a biasing force applied to the third member by the second biasing member is larger than a biasing force by the first biasing member.

5. The optical apparatus according to claim 1, wherein a biasing force of the first biasing member changes in accordance with a rotation angle when the second member is within a predetermined range of rotation angle, and the biasing force of the first biasing member does not change when the second member is outside the predetermined range of rotation angle.

6. The optical apparatus according to claim 4, wherein an opening portion for operating the operation member is provided in an outer peripheral portion of the optical apparatus, and when the drive unit is attached, an action portion provided in the drive unit passes through the opening portion and presses the operation member, and when the drive unit is detached, the second biasing member acts and the operation member closes the opening portion.

7. The optical apparatus according to claim 1, wherein even when the drive unit is attached to the optical apparatus, a biasing force of the first biasing member acts on the first member.

8. The optical apparatus according to claim 1, wherein the first member is a zoom operation ring for moving an optical system having an optical axis in the optical apparatus, the second member is a rotary ring held rotatably about the optical axis, and the third member is a linear movement ring that moves linearly along the optical axis.

9. The optical apparatus according to claim 1, wherein a friction member configured to apply the rotational load to the first member, and
wherein the first biasing member is in contact with the friction member at a plurality of points.

10. The optical apparatus according to claim 1, further comprising an attaching portion for fixing the drive unit.

11. An image pickup apparatus comprising:
an optical apparatus, the optical apparatus comprising:
a first member rotatable about an optical axis,
a second member rotatable about the optical axis,
a third member movable in an optical axis direction,
a first biasing member biasing the first member and configured to apply a rotational load to the first member, and
an adjustment mechanism configured to adjust the rotational load,
wherein the first member is rotatable manually or by a drive unit detachable from the optical apparatus,
wherein the optical apparatus includes an operation member that is operated in conjunction with attachment of the drive unit to the optical apparatus, and
wherein the adjustment mechanism rotates the second member about the optical axis by operating the operation member, move the third member in the optical axis direction by rotating, and change the rotational load,
wherein the image pickup apparatus comprises a drive unit configured to rotationally drive the first member, and an image pickup element configured to capture an image formed by the optical apparatus.
